(19) United States
(12) Patent Application Publication
(10) Pub. No.: US 2017/0150729 A1
(43) Pub. Date: Jun. 1, 2017

(54) METHOD OF PRODUCING A PIECE OF LAMINATED DOUGH, A PIECE OF LAMINATED DOUGH, AND A METHOD OF BAKING A PIECE OF LAMINATED DOUGH

(71) Applicant: Rheon Automatic Machinery Co., Ltd., Utsunomiya-shi (JP)

(72) Inventors: Yoshiaki Okazaki, Utsunomiya-shi (JP); Toshiyuki Tomizawa, Utsunomiya-shi (JP)

(73) Assignee: Rheon Automatic Machinery Co., Ltd., Utsunomiya-shi (JP)

(21) Appl. No.: 15/360,811

(22) Filed: Nov. 23, 2016

(30) Foreign Application Priority Data
Nov. 26, 2015 (JP) 2015-230352

(51) Int. Cl. A21D 10/00; A21D 8/06; A21D 8/04

(52) U.S. Cl. CPC A21D 10/002; A21D 8/047; A21D 8/06

(57) ABSTRACT

A method of producing a piece of laminated dough that is frozen after partial fermentation is provided. The method of producing the piece comprises the steps of: (a) mixing and kneading flour, water, yeast, gluten, and other materials to make a dough mass, (b) causing the dough mass to be formed in a belt-like shape, (c) putting fat on the formed dough to sandwich fat layers between dough layers to form a sheet of laminated dough in a long belt-like shape, (d) cutting the sheet to obtain a piece in a desired shape, (e) forming the piece into a piece in a desired shape, (f) fermenting the formed piece so that the specific volume of the piece becomes 1.2 to 1.8 cm³/g, (g) rapidly freezing the fermented piece, and (h) preserving the frozen piece in a freezer.

### RELATED APPLICATIONS

This application claims priority to Japanese Patent Application No. 2015-230352, filed Nov. 26, 2015, hereby incorporated by reference in its entirety as if fully set forth herein.

### BACKGROUND OF THE INVENTION

Technical Field

The present invention relates to a method of producing a piece of laminated dough that is formed from laminated dough wherein respective dough sheets are laminated with fat. It also relates to a method of baking the piece of laminated dough. Specifically, it relates to a method of producing a piece of laminated dough that has been frozen after partial fermentation, a piece of laminated dough that is produced by that method, and a method of baking the piece of laminated dough that has been thawed.

Background Art

Pastry, which includes croissants, is formed by using laminated dough wherein respective sheets of dough are laminated with fat. The pastry that has been industrially manufactured is delivered to customers and consumers, such as bakeries and individuals (collectively called “consumers”), in a frozen state and is baked by them.

A shaped piece of the laminated dough that has not been fermented and that is frozen and preserved is called “shaped and frozen dough.” The shaped and frozen dough is delivered to the consumers while it is frozen. It is thawed and fermented by the consumers before it is baked. For example, it is thawed for one to two hours before being baked. Further, it is fermented for one hour in a chamber that is controlled at a temperature of 30° C. and a humidity of 80%. The volume of the fermented dough expands to about 3.5 times the volume of the shaped and frozen dough. Then the fermented dough is baked in a baking oven. The volume of a finished product expands to about 4.5 times the volume of the shaped and frozen dough.

A shaped piece of the laminated dough that has been fully fermented and that is rapidly frozen and preserved is called “fermented and frozen dough” (see Patent Document No. 1). The fermented and frozen dough is baked in a baking oven without being thawed by the consumers. For example, a shaped piece of the laminated dough is fermented for 50 to 100 minutes in a chamber that is controlled to be at a temperature of 25 to 40° C. and a humidity of 70 to 80%. Then it is rapidly frozen for 50 minutes by a shock freezer at a temperature of −40° C. Then it is preserved in another freezer at a temperature of −25° C. The volume of the fermented piece of the laminated dough expands to about 4 times the volume of the shaped and frozen dough. Its specific volume is about 3.5 cm³/g.

For example, the fermented and frozen dough is baked for 17 minutes by a baking oven at a temperature of 200° C. without being thawed, by the consumers. The volume of the baked product expands to 4.5 or more times the volume of the shaped piece of the laminated dough.

Patent Document No. 1

Japanese Patent Laid-open Publication No. H6-040793

Problems to Be Solved by the Invention

About the shaped and frozen dough, since the products have been distributed to consumers before being fermented, the volume of the products is small, to thereby reduce the cost of transportation and the space for preserving them at the consumers. However, the consumers must invest money in equipment, such as a temperature-controlled chamber, and must secure space for the equipment. Further, since a long time is required for thawing and fermenting dough before baking, there is a problem in that a prompt response to an urgent order is difficult to make.

About the fermented and frozen dough, since the volume of the dough becomes large after being fermented, there is a problem in that the cost of transportation is higher than that for the shaped and frozen dough. Further, fully fermented products (the piece of the laminated dough) have respective structures of many bubbles, and the film of the dough that forms the bubbles is thin. Thus there is a problem in that the products are fragile. The respective structures of the bubbles may be damaged while being transported or handled. Thus there is also a problem in that the quality of the baked products (the piece of the laminated dough) deteriorates. Further, the fermented and frozen dough has a thin layer so that, when it is warmed to room temperature, the surface of it is immediately thawed and starts to become soft. Thus the operation to put it in a baking oven must be carried out within a short time.

To solve these problems, the present invention aims to provide a method of producing a piece of laminated dough of which the volume can be smaller than that of the fermented and frozen dough when it is frozen and preserved. Further, it aims to provide a piece of laminated dough by which no fermenting process is required before being baked, and the time for thawing, i.e., from the time when taking it out of a freezer to the time when putting it in a baking oven, can be shorter than that of the shaped and frozen dough. It also aims at a method of baking that piece of the laminated dough.

### SUMMARY OF THE INVENTION

Means to Solve the Problems

The method of producing a piece of laminated dough of the present invention is characterized in that the method comprises the steps of:
(a) mixing and kneading flour, water, yeast, gluten, and other materials required for producing a desired type of bread, to make a dough mass,
(b) causing the dough mass to be formed in a belt-like shape,
(c) putting fat on the formed dough to sandwich fat layers between dough layers to thereby form a sheet of laminated dough that has a long belt-like shape,
(d) cutting the sheet of the laminated dough to obtain a piece of the sheet of the laminated dough in a desired shape,
(e) forming the piece of the sheet of the laminated dough into a piece of the laminated dough in a desired shape,
(f) fermenting the formed piece of the laminated dough so that a specific volume of the piece of the laminated dough becomes 1.2 to 1.8 cm3/g,
(g) rapidly freezing the fermented piece of the laminated dough, and
(h) preserving the rapidly frozen piece of the laminated dough in a freezer.

The method of the present invention may be characterized in, in the step of (a), mixing and kneading a part of the flour, the water, the yeast, the gluten, and the other materials, so as to have them be fermented and then frozen, to obtain frozen dough, and thereafter mixing and kneading the frozen dough with the rest of the flour, the water, the yeast, the gluten, and the other materials, to obtain the dough mass.

The method of the present invention may be characterized in, in the step of (b), stretching the dough mass to form a belt-like shape while subjecting it to vibrations.

The method of the present invention may be characterized in, in the step of (c), overlapping and joining sheets of the laminated dough that have a belt-like shape in a desired size to form a sheet of laminated dough that has a long belt-like shape.

The method of the present invention may be characterized in, in the step of (c), stretching the laminated dough to form a long belt-like shape while subjecting it to vibrations.

The method of the present invention may be characterized in, in the step of (g), rapidly freezing the piece of the laminated dough at a temperature of −25° C. or lower.

The method of the present invention may be characterized in, in the step of (h), preserving the piece of the laminated dough in a freezer at a temperature of −20° C. or lower.

A piece of laminated dough of the present invention is characterized in that it is manufactured by any of the above methods.

The method of baking a piece of laminated dough of the present invention is characterized in that the method comprises the steps of:
(i) thawing the frozen piece of the laminated dough so that the temperature at the center of it becomes −11 to 4° C., and
(j) baking the thawed piece of the laminated dough in a baking oven.

The method of baking the piece of the laminated dough of the present invention may be characterized in, in the step of (i), thawing the frozen piece of the laminated dough for 10 to 35 minutes at a temperature of 18 to 27° C.

The method of baking the piece of the laminated dough of the present invention may be characterized in, in the step of (j), supplying steam into the baking oven when baking is started, and baking the thawed piece of the laminated dough for 15 to 22 minutes at a temperature of 160 to 190° C.

By the present invention, since the shaped piece of the laminated dough is less fermented than when under conditions for full fermentation, a piece of the laminated dough that has a small volume can be produced.

When dough is produced by mixing and kneading the materials, or laminated dough is produced by laminating the dough with fat, the dough or the laminated dough is stretched to be thin while it is subjected to vibrations. Thus the gluten network of the dough, i.e., a network made of gluten, is not broken, so that a piece of the laminated dough of a good quality can be produced.

The shaped piece of the laminated dough occupies a smaller space in comparison with the fully fermented one when it is preserved in a freezer. Further, the cost of transportation in the frozen state can be reduced.

When the frozen piece of the laminated dough is baked, no step for fermenting is required, unlike for the shaped and frozen dough. Further, the time required for thawing can be shortened, so that an urgent order can be promptly responded to. Handling the product is facilitated, since more to put it in a baking oven after it is warmed to room temperature is available than that for the fermented and frozen dough.

No step of fermenting is required, unlike for the shaped and frozen dough. Thus a piece of the laminated dough can be stably baked by just adjusting the baking oven, without changing the fermenting conditions of the piece of the laminated dough before baking.

The basic Japanese patent application, No. 2015-230352, filed Nov. 26, 2015, is hereby incorporated by reference in its entirety in the present application.

The present invention will become more fully understood from the detailed description given below. However, the detailed description and the specific embodiments are only illustrations of the desired embodiments of the present invention, and so are given only for an explanation. Various possible changes and modifications will be apparent to those of ordinary skill in the art on the basis of the detailed description.

The applicant has no intention to dedicate to the public any disclosed embodiment. Among the disclosed changes and modifications, those which may not literally fall within the scope of the present claims constitute, therefore, a part of the present invention in the sense of the doctrine of equivalents.

The use of the articles “a,” “an,” and “the” and similar referents in the specification and claims are to be construed to cover both the singular and the plural forms of a noun, unless otherwise indicated herein or clearly contradicted by the context. The use of any and all examples, or exemplary language (e.g., “such as”) provided herein is intended merely to better illuminate the invention, and so does not limit the scope of the invention, unless otherwise stated.

### DETAILED DESCRIPTION OF THE PREFERRED EMBODIMENTS

As a first embodiment of the present invention, a method of producing a piece of laminated dough is now discussed. An exemplary method of industrially producing croissants is discussed. The croissants, i.e., the pieces of laminated dough, are shaped from laminated dough that is manufactured from sheets of dough and fat. The dough is made by mixing and kneading flour, water, yeast, gluten, a dough conditioner, and other materials required for producing a desired type of bread, in a mixer. The temperature of the kneaded dough (the temperature after kneading) was 14° C. (58° F.).

An example of the compositions is shown in Table 1, where the weight of the flour in the dough is set to be 100%.

TABLE 1

| | |
|---|---|
| flour | 90% |
| sugar | 10% |
| fat-free milk powder | 3% |
| butter flavor | 1.4% |
| yeast | 14% |
| butter | 5% |
| malt | 0.3% |
| salt | 1.5% |
| gluten | 9% |
| dough conditioner | 3% |
| frozen dough A | 20% |
| chilled water | 58% |

The frozen dough A in Table 1 is fermented dough that is made mainly of flour. For example, it may be dough for croissants or dough that is called ciabatta. The frozen dough A is made by containing flour in the proportion of 10% to the entire weight of the flour to be used. Because such fermented dough is mixed in the dough, dough extensibility is improved and a strong gluten network is formed in the dough. Thus when the dough is fermented or baked, an ability to hold carbon dioxide that is within fine bubbles that are distributed in the dough and that is derived from the yeast is enhanced. An ability to thermally expand water in the dough or the fat and to vaporize it is also enhanced.

The dough that has been mixed and kneaded as discussed above is caused to rest at the temperature of 14° C. for 20 minutes. Then it is supplied to the hopper of a dough feeder (such as Model VX422, available from Rheon Automatic Machinery Co. Ltd., Japan) to form a dough sheet in a belt-like shape that has the width W of 380 mm and the thickness T of 45 mm. The dough sheet is extended in the width direction by means of a cross roller. Then the dough sheet is stretched in both the width and transporting directions by means of a first stretcher (such as Model SM603, available from Rheon) to become a thin sheet that has a width W of 700 mm and a thickness T of 8 mm.

The cross roller is a roller that reciprocates in the width direction of the dough sheet while it rotates so as to stretch the dough sheet in the width direction. Thereby the dough becomes thinner. The first stretcher comprises a lower stretching roller that is disposed downstream in a conveyor for carrying the dough in. It has a large diameter. It also comprises an upper stretching roller that is disposed above the lower stretching roller and has stretching rollers that revolve in a circular pattern while they rotate. The dough that has been stretched in the width direction is stretched in the transporting direction when it passes through the gap between the lower stretching roller and the upper stretching roller. At this time, the speed of the operation of the lower stretching roller, i.e., the speed at the surface of the rotating roller, is set to be 2.9 times the speed of the operation of the conveyor for carrying the dough in.

Then the fat that has been shaped in a required width and a thickness T of 8.5 mm is continuously supplied at the center of the stretched dough sheet by a pump for the fat. The fat in a belt-like shape is put on the upper surface of the dough sheet. Then the side parts of the dough sheet (the edges of the dough sheet where the fat is not put) are folded and overlapped on the fat one by one to form a dough sheet that is wrapped around the fat. The thickness T of it is reduced by means of gauge rollers to be 35 mm. The weight of the fat is set to be 28% of the total weight, which includes the weight of the dough. The fat may be selected from a group of butter, margarine, and shortening, for example.

The dough sheet that wraps the fat is stretched by a second stretcher (Model SM601, available from Rheon) to be thin, with a width W of 370 mm and a thickness T of 8 mm. This second stretcher stretches the dough sheet by applying vibrations by means of stretching rollers while pulling it. By the second stretcher the speed of the operation of the stretching rollers is set to be 4.4 times the speed of the operation of the conveyor for carrying the dough in.

The stretched dough sheet is folded in a zigzag pattern by means of a first apparatus for laminating the dough sheet (Model LM406, available from Rheon). The dough sheet is stacked in four layers on the lower conveyor that is disposed perpendicular to the transporting direction. The folded dough sheet has a width W of 550 mm and a thickness T of 32 mm.

The third stretcher (Model SM032, available from Rheon) has first, second, and third conveyor belts in series in the transporting direction. The respective speeds V1, V2, and V3 of the operations of the first, second, and third conveyor belts become sequentially faster. Upper stretching rollers, each of which has multiple stretching rollers that revolve in an oval pattern while rotating, are provided above the first, second, and third conveyor belts. The respective gaps between the conveyor belts and the upper stretching rollers sequentially become narrower.

The folded dough sheet is pressed against the conveyor belts by means of the stretching rollers of the third stretcher. It is subject to tensile stresses that are generated by the differences in the speeds of the first, second, and third conveyor belts. At the same time, it is vibrated by repeated loads that are generated by the rotations and movements of the stretching rollers (the motion of rotations and revolutions in an oval pattern). The dough sheet that has been stretched in the folded state is stretched to be a sheet of the laminated dough that has a width W of 600 mm and a thickness T of 7 mm and has four alternating dough and fat layers. The speed of the operation of the third conveyor belt is set to be 4.5 times that of the first conveyor belt.

The sheet of the laminated dough with four layers is folded in a zigzag pattern by means of a second apparatus for folding and laminating the dough sheet (Model 0M048, available from Rheon). The sheet of the laminated dough is stacked in four layers on the lower conveyor that is disposed perpendicular to the transporting direction. The folded sheet of the laminated dough has a width W of 730 mm and a thickness T of 40 mm.

The folded sheet of the laminated dough is stretched by a fourth stretcher (Model SM319, available from Rheon) to be thin, with a width W of 870 mm and a thickness T of 8 mm. The sheet of the laminated dough that has been stretched in the folded state has 16 alternating dough and fat layers. The speed of the operation of the third conveyor belt is set to be 4.0 times that of the first conveyor belt.

The sheet of the laminated dough is stretched by a fifth stretcher (Model SM319, available from Rheon) to be thin, with a width W of 920 mm and a thickness T of 5 mm. The speed of the operation of the third conveyor belt is set to be 1.8 times that of the first conveyor belt. The stretched sheet of the laminated dough that is stretched by the fourth and fifth stretchers is stretched by subjecting it to the repeated loads while being pulled. Thus the gluten network in the dough layers is not broken, and the sheet of the laminated dough can be stretched in a manner that the dough layers and the fat layers correctly alternate.

The sheet of the laminated dough that has been stretched to have a final thickness is cut by an apparatus for cutting (a cutter for croissants) to obtain a triangular or trapezoidal piece of the sheet of the laminated dough. The piece of the sheet of the laminated dough is rolled by an apparatus for rolling up (a molder) to be about 3.2 to 3.5 windings to form the piece of laminated dough. The piece of laminated dough is shaped to have a central part that is thicker than both ends. Depending on the requirements, it is bent by an apparatus for bending to be a U-shape, a C-shape, or an O-shape. The apparatus for cutting, the apparatus for rolling up, and the apparatus for bending may be any known ones.

The piece of laminated dough is conveyed to a spiral-type proofer to be fermented at a temperature of 27° C. (81° F.) and a humidity of 75% in a chamber, for 30 to 40 minutes, based on the size of the piece of laminated dough. Then the fermented piece of laminated dough is conveyed to a spiral-type freezer to be quickly frozen at −30° C. (−22° F.) in a chamber for one hour. The frozen piece of laminated dough is preserved at −22° C. (−7.6° F.) in a freezer. Here, the term “quick freeze” means to freeze food so that the temperature is dropped so as to pass the range of temperature to freeze water in it within 30 minutes, for example. The temperature in the chamber should be equal to, or less than, −18° C. The temperature in the chamber for quickly freezing is preferably equal to, or less than, −25° C. The temperature in the chamber for preserving in the freezing condition is preferably equal to, or less than, −20° C.

Now, the change in the specific volumes of the shaped pieces of laminated dough is discussed. The specific volumes are discussed by using 10 samples of the pieces of laminated dough weighing 1.25 oz (about 35.4 g) and 10 samples weighing 3.25 oz (about 92.1 g), and averaging them. To compare them with the partially-fermented and frozen dough of the present invention, the specific volumes of the pieces of laminated dough that have been frozen after being shaped are discussed. The specific volumes of the products with the weight of 1.25 oz and 3.25 oz are 0.85 cm³/g and 0.88 cm³/g, respectively.

The mean specific volumes of the pieces of laminated dough with the weights of 1.25 oz and 3.25 oz that have been quickly frozen after being partially fermented are 1.35 cm³/g and 1.55 cm³/g, respectively. The respective specific volumes of the pieces of laminated dough with the weights of 1.25 oz and 3.25 oz are 1.28-1.5 cm³/g and 1.32-1.8 cm³/g, respectively. That is, they are generally within the range of 1.2-1.8 cm³/g. The partially-fermented pieces of laminated dough are fermented and expanded in the temperature-controlled chamber so that the shaped pieces of laminated dough with the weights of 1.25 oz and 3.25 oz expand to 1.6 times and 1.77 times in volume, respectively. Inside the pieces of laminated dough that have been quickly frozen after being fermented, fine bubbles are formed to contain carbon dioxide that is derived from yeast.

Thus the piece of laminated dough that has been preserved in a freezer has a volume that is less than a half of that of the fermented and frozen dough that has been preserved in a freezer (for example, 3.5 cm³/g). Namely, twice the number of products can be packed in a carton that is used for delivery. The cost for delivery can be reduced by using the piece of laminated dough of the present invention.

Next, baking the frozen pieces of laminated dough is discussed. The pieces of laminated dough that have been taken out of the freezer are arranged on a pan for baking. They are left in a room at 24° C. (75.2° F.) for 30 minutes to thaw. The temperatures at the centers of the thawed pieces of laminated dough with the weights of 1.25 oz and 3.25 oz are −2.5° C. (27.5 F) and −8° C. (17.6 F), respectively. Incidentally, the products with the weights of 1.25 oz and 3.25 oz have been preserved in a freezer for 8 days and 7 days, respectively.

The thawed piece of laminated dough is put in a baking oven to be baked. The baking temperature and time for the baking are set at 160° C. and 22 minutes. At the beginning of the baking, 300 cm³ of steam is supplied into the chamber of the baking oven so as to have the humidity be about 70 to 80%.

The specific volumes of the baked pieces of laminated dough with the weights of 1.25 oz and 3.25 oz are 4.8 cm³/g and 5.9 cm³/g, respectively. They expand to about 5.7 times and 6.7 times the shaped pieces of laminated dough, respectively. They have a structure that has thin inner layers. Thus the layers of the dough that contain air bubbles are thin so as to have a crisp and short texture. By the present invention the baked piece of laminated dough can expand to a degree that is equal to, or greater than, that of the shaped and frozen dough and the fermented and frozen dough. Namely, the piece of laminated dough has a good ability to hold the carbon dioxide that is within the fine bubbles that are distributed in the dough and that is derived from the yeast, and a good ability to thermally expand water in the dough or the fat and to vaporize it.

The values that are used in the above discussion are not limited to them, but may be changed. Now, a working example is discussed in relation to the time for thawing a piece of laminated dough with the weight of 1.25 oz, and the temperature at the center of it. The pieces of laminated dough that have been thawed at the room temperature of 24° C. (75.2° F.) for 10 minutes (the temperature at the center is −11° C.), for 33 minutes (the temperature at the center is −4° C.), and for 56 minutes (the temperature at the center is 20° C.), are baked in the same way as in the above-mentioned example. The specific volumes of the pieces of laminated dough after baking are 4.58 cm³/g for a product thawed for 10 minutes, 4.74 cm³/g for a product thawed for 33 minutes, and 4.48 cm³/g for a product thawed for 56 minutes.

Now, a working example is discussed in relation to the temperature and the time for baking a piece of laminated dough with a weight of 1.25 oz. The frozen pieces of laminated dough that have been thawed at a room temperature of 24° C. (75.2° F.) for 30 minutes are used. They are baked based on the necessary baking time so that their colors when baked are almost the same for each of the baking temperatures. The specific volumes of the baked pieces are measured. The results show that the specific volumes are 4.16 cm³/g for a baking temperature of 140° C. and a baking time of 30 minutes, 4.66 cm³/g for a baking temperature of 160° C. and a baking time of 22 minutes, and 4.48 cm³/g for a baking temperature of 180° C. and a baking time of 15 minutes.

Thus it was found that a partial-fermentation of the piece of laminated dough of the present invention before freezing is effective. The time for fermentation is shorter than that for the existing fermented and frozen dough. However, carbon dioxide is generated in the dough parts of the shaped piece of laminated dough. Because the dough around the fine bubbles has been once extended, the dough may easily expand when being baked after thawing. It is observed that a piece of laminated dough keeps the same specific volume within two months after being shaped.

Now, the measured values for the piece of laminated dough with a mean weight of 60 g, which has 24 layers of the fat, are discussed. The mean specific volume of the shaped pieces of laminated dough that have been rolled to be about 3.2 to 3.5 windings is 0.89 cm³/g. The shaped pieces of laminated dough are fermented in a temperature-controlled chamber at a temperature of 28° C. and a humidity of 75% for 30 minutes. Then they are quickly frozen in a shock freezer at −30° C. for 60 minutes. Then they are preserved in a freezer at −20 to −25° C. The specific volumes of the frozen pieces of laminated dough range from 1.34 to 1.69 cm³/g and their mean value is 1.57 cm³/g. They are thawed at the temperature of 24.5° C. for 35 minutes so that the temperatures at their centers are 0 to 4° C. Then they are baked in a baking oven at a baking temperature of 190° C. and a baking time of 22 minutes. At the initiation of baking, steam is supplied into the chamber for 15 seconds. The specific volumes after baking range from 4.5 to 4.7 cm³/g and their mean value is 4.6 cm³/g. Incidentally, the thawing temperature may be at room temperature. For example, it is preferably 18° C. or above, or less than 27° C., at which yeast plants are active. At this range of temperatures, the fat is prevented from melting or liquefying.

As is clear from the above discussion, by partially fermenting the shaped piece of laminated dough so that the specific volume of it becomes 1.2 to 1.8 cm³/g, and then quickly freezing it, the existing problems can be solved. By thawing the frozen and partial-fermented piece of laminated dough so that the temperature at the center of it becomes −11 to 4° C., the specific volume of it after baking can be 4.5 cm³/g or more. Since the piece of laminated dough to be thawed is formed by dough that contains fine bubbles, the thickness of the dough is greater than that of the fermented and frozen dough. Thus it does not easily soften.

By using the frozen and partially-fermented piece of laminated dough of the present invention, thawing can be carried out at the temperature of 18 to 27° C. for 10 to 35 minutes. Thus more time is available to put the piece of laminated dough into a baking oven after being thawed in comparison to where fermented and frozen dough is used. Handling the product is facilitated for a user.

In the above discussion, the dough sheet in a belt-like shape is formed so that the fat is wrapped by it and thereafter the dough sheet is stretched by a stretcher. However, a dough sheet in a belt-like shape that has a predetermined size may be used and the laminated dough may be formed by putting the fat on it by means of a dough sheeter. The laminated dough that has been preserved at a low temperature (for example, −1 to 1° C.) may be laminated and may be continuously stretched to obtain a long sheet of the laminated dough. The sheet of the laminated dough is vibrated by repeatedly applying loads by means of stretching rollers while applying a tensile stress on it. Thus a sheet of laminated dough that is homogeneous can be obtained with the layers of the dough and the fat being correctly laminated.

1. A method of producing a piece of laminated dough, the method comprising the steps of:
(a) mixing and kneading flour, water, yeast, gluten, and other materials required for producing a desired type of bread, to make a dough mass,
(b) causing the dough mass to be formed in a belt-like shape,
(c) putting fat on the formed dough to sandwich fat layers between dough layers to thereby form a sheet of laminated dough that has a long belt-like shape,
(d) cutting the sheet of the laminated dough to obtain a piece of the sheet of the laminated dough in a desired shape,
(e) forming the piece of the sheet of the laminated dough into a piece of the laminated dough in a desired shape,
(f) fermenting the formed piece of the laminated dough so that a specific volume of the piece of the laminated dough becomes 1.2 to 1.8 cm3/g,
(g) rapidly freezing the fermented piece of the laminated dough, and
(h) preserving the rapidly frozen piece of the laminated dough in a freezer.

2. The method of claim 1, wherein, the step of (a) is characterized in mixing and kneading a part of the flour, the water, the yeast, the gluten, and the other materials, so as to have them be fermented and then frozen, to obtain frozen dough, and thereafter mixing and kneading the frozen dough with the rest of the flour, the water, the yeast, the gluten, and the other materials, to obtain the dough mass.

3. The method of claim 1, wherein the step of (b) is characterized in stretching the dough mass to form a belt-like shape while subjecting it to vibrations.

4. The method of claim 1, wherein the step of (c) is characterized in overlapping and joining sheets of the laminated dough that have a belt-like shape in a desired size to form a sheet of laminated dough that has a long belt-like shape.

5. The method of claim 1, wherein the step of (c) is characterized in stretching the laminated dough to form a long belt-like shape while subjecting it to vibrations.

6. The method of claim 1, wherein the step of (g) is characterized in rapidly freezing the piece of the laminated dough at a temperature of −25° C. or lower.

7. The method of claim 1, wherein the step of (h) is characterized in preserving the piece of the laminated dough in a freezer at a temperature of −20° C. or lower.

8. A piece of laminated dough that is manufactured by the method of claim 1.

9. A method of baking a piece of laminated dough of claim 8, the method comprising the steps of:
(i) thawing the frozen piece of the laminated dough so that the temperature at the center of it becomes −11 to 4° C., and
(j) baking the thawed piece of the laminated dough in a baking oven.

10. The method of claim 9, wherein the step of (i) is characterized in thawing the frozen piece of the laminated dough for 10 to 35 minutes at a temperature of 18 to 27° C.

11. The method of claim 9, wherein the step of (j) is characterized in supplying steam into the baking oven when baking is started, and baking the thawed piece of the laminated dough for 15 to 22 minutes at a temperature of 160 to 190° C.
